(19) United States
(12) Patent Application Publication
(10) Pub. No.: US 2008/0286719 A1
(43) Pub. Date: Nov. 20, 2008

(54) Retraction Thread With Improved Absorbency

(75) Inventors: Barbara Muller, Langenau (DE); Hans-Ruedi Hefti, Turbenthal (CH); Stephan Lampl, Altstatten (CH)

Correspondence Address: KATTEN MUCHIN ROSENMAN LLP, 575 MADISON AVENUE, NEW YORK, NY, 10022-2585, US

(73) Assignee: COLTENE/WHALEDENT GMBH+CO.KG, Langenau (DE)

(21) Appl. No.: 11/631,141

(22) PCT Filed: Jul. 1, 2005
(86) PCT No.: PCT/EP05/07098

§ 371 Date: Sep. 27, 2007

(30) Foreign Application Priority Data
Jul. 1, 2004 (DE) 10 2004 032 099.3

(51) Int. Cl. A61C 9/00

(52) U.S. Cl. 433/136; 57/250; 57/295; 428/395

(57) ABSTRACT

The invention relates to a retraction thread, especially a dental retraction thread for use in dentistry, that is distinguished by the fact that it has yarns produced by an air vortex process.

The present invention relates, according to its preamble, to a retraction thread, such as is used especially as a dental retraction thread for the gingival sulcus in dentistry.

In dentistry, it is generally necessary in prosthetic or partial prosthetic dental treatment, such as the manufacture of an inlay, onlay, crown or bridge, for an impression to be prepared in order to shape the (partial) prosthesis. When, in order to shape the (partial) prosthesis, that impression needs to be taken in the region of the gum (gingiva), a problem arises because, to prepare an accurate impression, the gum needs to be retracted and, in addition, the bleeding that frequently occurs has to be stopped.

For that purpose so-called retraction threads are inserted into the pocket-shaped recess (sulcus) between gingiva and tooth, by means of which the gum can be retracted mechanically. It is intended, by means of the retractions threads, for it to be possible for liquids, such as blood or saliva, to be absorbed in order to allow an accurate impression to be taken by “keeping the tooth dry”. For the purpose of stopping blood, the retraction threads are, in addition, usually impregnated with astringent or haemostatic active ingredients, which are released at the gum where they have their haemostatic effect.

A disadvantage of the retraction threads known from the prior art is especially that the capacity of the retraction threads to absorb liquid is unsatisfactory or not satisfactory enough; a satisfactory capacity is an indispensable prerequisite, however, for the expedient use of retraction threads in the gingival sulcus. As a result of inadequate absorbency, liquids, such as blood or saliva, are not kept away from the tooth completely, with the result, also, that errors may consequently occur in taking an impression.

The problem underlying the present invention is accordingly to provide a retraction thread having an improved absorbency by means of which the problems mentioned can be avoided or reduced.

The problem is solved by a retraction thread, especially a dental retraction thread for use in dentistry, that has at least one yarn produced by means of an air vortex process. Advantageous developments of the invention are indicated by the features of the sub-claims.

According to the proposal of the invention, the retraction thread is distinguished by the fact that it has at least one yarn produced by means of an air vortex process, and especially consists of one, two or more yarns produced by means of an air vortex process. The yarn or yarns are advantageously composed of a polymer material, or especially advantageously of a plurality of polymer materials, especially in the form of material blends, which may be, especially, a highly elastic (HE) polyamide, polyurethane, polyethylene, polyacrylic, polychloride and/or polyester multifilament. As tests by the applicants have shown, such yarns have an especially high absorbency, especially in respect of water, and an especially high swelling capacity, so that they are able to fulfil especially well the retracting effect of the retraction threads on the gum in the gingival sulcus. The retraction threads according to the invention change in volume on contact with liquids (especially water), and are consequently capable of widening the sulcus, thus allowing improved accuracy in taking an impression. This independent change in volume can be achieved by swelling or by other reactions, such as, for example, by memory effects in the material or by chemical foams; but especially by swelling. The change in volume may be up to 20%, 30% or even up to 50%. In addition, retraction threads produced from such yarns are able to absorb liquids, such as blood or saliva, especially well, so as to render possible an accurate impression. Without there being any limitation thereto, capillary effects are mentioned as a possible reason for the high absorbency of the yarns produced by air vortex.

The air vortex processes that can be used to produce the yarns for the retraction threads according to the invention are air vortex processes well-known to the person skilled in the art which are currently used for texturing filaments and which are also known as air-jet blowing processes. Accordingly there is no need for further details thereof to be given herein. (Air vortex processes are described, for example, in U.S. Pat. No. 6,088,892, US 2003110754, U.S. Pat. No. 6,564,438, WO 0052240 and US 2002073684.) In such processes, filaments are usually twisted by a pressure medium, such as compressed air, which is supplied through a nozzle. As a result a textile character is imparted to the filaments. The air vortex process may be carried out as a cold process or as a hot process, it being possible for the latter to be effected especially by means of high-pressure steam, which has the effect that the filaments are twisted and fixed.

In an especially advantageous embodiment of the retraction thread according to the invention, the thread is coated on its surface with a soluble substance, especially a water-soluble substance, that laminates the surface at least partially, advantageously completely. The substance may be, for example, starch, wax, gluten, casein or gelatine. The effect of coating the retraction thread with a soluble substance is that the retraction thread is able to swell in situ only when the soluble substance has been removed from its surface by dissolution in the surrounding fluid (for example saliva). Alternatively, the retraction thread can for that purpose be immersed shortly before use in, for example, alcohol, to dissolve the coating in order then to be fully expanded in the sulcus (memory effect). With that premise, the diameter of the retraction thread can be substantially reduced, that is, the retraction thread can be made substantially thinner. A retraction thread that is comparatively thinner, however, can be inserted substantially more easily, more accurately and, especially, more deeply into the sulcus, in order to be positioned in a stable location for effective widening of the sulcus.

In a further advantageous embodiment of the retraction thread according to the invention, the thread comprises at least one pharmaceutical active ingredient, such as an astringent active ingredient or antibiotic active ingredient. Examples of active ingredients that can be used are disclosed, for example, in EP 1 188 419. The concentrations of active ingredients used depend largely on the substance. Chlorhexidine may be used, for example, in a solution of from 0.2 to 5%. In the case of blood-stopping agents, the concentrations are, for example, from 10 to 30%. An embodiment of a retraction thread having at least one cavity for accommodating at least one such pharmaceutical active ingredient is especially advantageous. In such an arrangement, the fibres (yams) of the retraction thread may be in the form of hollow fibres. The pharmaceutical active ingredients contained, for example, in the cavities, are released at the gum from the retraction threads positioned in situ and, in addition to the fluid-absorbing action of the retraction thread, are able there, for example by means of an astringent action, to assist in making an accurate impression possible. Further actions are guarding against infections and means for the accelerated healing of wounds. Filling the cavities with a pharmaceutical active ingredient is advantageous in terms of a homogeneous production of the retraction threads and also improves the storage stability of the pharmaceutical active ingredients, since an impregnating process in liquid medium, as in the case of the retraction threads known from the prior art, is inapplicable.

The retraction thread according to the invention may advantageously be braided or knitted. Particularly advantageously, knitted retraction threads, especially, that are produced especially from air-twisted yarns of mixed polymer materials, are distinguished by a high elasticity.

In the dry state, the threads have a diameter of, for example, from 0.05 to 0.5 mm, preferably from 0.1 to 0.3 mm and especially of about 0.2 mm.

The invention will now be explained by way of an embodiment example with reference to the accompanying drawings in which

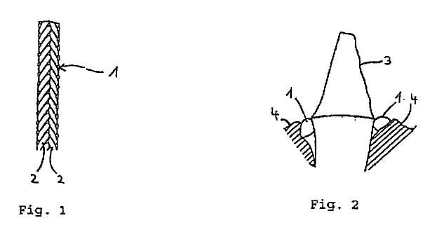

FIG. 1 shows an embodiment example of the retraction thread according to the invention;

FIG. 2 shows an exemplary use of the retraction thread according to the invention in a gingival sulcus.

FIG. 1 shows an embodiment example of the retraction thread 1 according to the invention in which the yarns 2, textured in an air vortex process, are knitted together. The yarns consist of a polymer blend material, which is selected from a polyamide-polyester mixture. The surface of the retraction thread is coated with water-soluble starch (not shown). The diameter of the retraction thread is about 0.2 mm. The yarns are formed as hollow fibres and contain an astringent active ingredient and also an anti-bacterial active ingredient.

FIG. 2 shows the use of the retraction thread 1 of FIG. 1 in a gingival sulcus. To widen the gingival sulcus, that is the pocket-shaped recess between tooth 3 and gum 4, the retraction thread 1 is inserted into the pocket-shaped recess, for which advantageously a tool provided with a point is used. As a result of the comparatively small diameter of the retraction thread 1, it is very easy for the user to bring the retraction thread into a stable position for widening the sulcus. Once the recess between tooth and gum has been widened, an impression of the tooth 1 can be taken.

1. Dental retraction thread (1)
characterised in that
it has at least one yarn (2) produced by an air vortex process.

2. Retraction thread according to claim 1,
characterised in that
the yarn contains one or more polymer materials, selected especially from polyamide and polyester.

3. Retraction thread according to claim 1,
characterised in that
it is coated on its surface with a soluble substance.

4. Retraction thread according to claim 3,
characterised in that
the soluble substance is starch.

5. Retraction thread according to claim 1,
characterised in that
it comprises at least one cavity for accommodating at least one pharmaceutical active ingredient.

6. Retraction thread according to claim 5,
characterised in that
the pharmaceutical active ingredient is selected from an astringent active ingredient and antibacterial active ingredient.

7. Retraction thread according to claim 1,
characterised in that
it is knitted or braided.

8. Retraction thread according to claim 1,
characterised in that
its volume increases after insertion into the sulcus.
